(19) United States
(12) Patent Application Publication
(10) Pub. No.: US 2022/0385173 A1
(43) Pub. Date: Dec. 1, 2022

(54) POWER FACTOR CORRECTION CIRCUIT AND INDUSTRIAL ROBOT

(71) Applicant: ABB SCHWEIZ AG, Baden (CH)

(72) Inventors: Sheng Zong, Beijing (CN); Guoxing Fan, Beijing (CN); Mei Liang, Beijing (CN)

(21) Appl. No.: 17/755,961

(22) PCT Filed: Nov. 21, 2019
(86) PCT No.: PCT/CN2019/119881

§ 371 Date: May 12, 2022

(51) Int. Cl. H02M 1/42; H02M 1/00; H02M 7/25

(52) U.S. Cl. CPC H02M 1/4233; H02M 1/0048; H02M 7/25

(57) ABSTRACT

Embodiments of present disclosure relates to a power factor correction circuit and an industrial robot. The power factor correction circuit has first and second AC terminals, first and second DC terminals, a first input inductor connected to the first AC terminal, a second input inductor connected to the second AC terminal, a first coupling inductor, configured to suppress a leakage current of the power factor correction circuit.

### FIELD

Embodiments of present disclosure generally relate to the field of power conversion, and more particularly, to a power factor correction circuit and an industrial robot including the power factor correction circuit.

### BACKGROUND

A conventional power module for an industrial robot typically includes a passive diode full bridge rectifier. The full bridge rectifier can only provide a unidirectional power conversion capability. However, during operation of the robot, frequent brakes of motors in the robot may produce large regenerative power. The regenerative power may be dissipated on bleeder resistors in the power module, leading to lower efficiency of the power module and higher thermal increase of the power module and a controller cabinet of the robot. In addition, the power factor of the passive diode full bridge rectifier is very poor, which would adversely contaminate the power grid. Therefore, a power factor correction (PFC) circuit with a bidirectional power conversion capability is required to improve the performance of the power module.

One major problem for the PFC circuit in the robot is a large leakage capacitance including a leakage capacitance between windings and bearings in the motors, a leakage capacitance between cables, Y capacitors between a DC bus and an earth, and the like. As a high frequency common mode (CM) voltage swings, a large residual current may be generated. The large residual current is unacceptable for small and middle size robots. Therefore, the PFC circuit for the robot needs to have a leakage current suppression capability.

On the other hand, the size of the whole controller in the robot is limited for business benefit. It requires not only small size but also high efficiency of the PFC circuit to mitigate the cooling burden of the whole controller, especially for the controller cabinet that has no air exchange with outside.

Thus, there is need for a PFC circuit with the bidirectional power conversion capability, the leakage current suppression capability and small size.

### SUMMARY

In view of the foregoing problems, various example embodiments of the present disclosure provide a PFC circuit with the bidirectional power conversion capability which may minimize the size of the PFC circuit while suppressing the leakage current.

In a first aspect of the present disclosure, example embodiments of the present disclosure provide a power factor correction (PFC) circuit. The power factor correction circuit comprises first and second AC terminals; first and second DC terminals; a first input inductor connected to the first AC terminal; a second input inductor connected to the second AC terminal; a first coupling inductor comprising a first plurality of windings, each of the first plurality of windings comprising a first end connected to the first input inductor and a second end; a second coupling inductor comprising a second plurality of windings of the same number as the first plurality of windings, each of the second plurality of windings comprising a first end connected to the second input inductor and a second end; a power converting unit comprising a plurality of branches connected in parallel between the first and second DC terminals, each of the branches comprising high-side and low-side controllable semiconductor devices, wherein the second end of each of the first and second plurality of windings is connected to a middle point between the respective high-side and low-side controllable semiconductor devices; and a switching circuit arranged between the first and second AC terminals and the second DC terminal and configured to suppress a leakage current of the power factor correction circuit.

In some embodiments, each of the high-side and low-side controllable semiconductor devices comprises MOSFET.

In some embodiments, the switching circuit comprises: first and second controllable bidirectional switches connected in series between the first and second AC terminals; and a capacitor connected between a connection point between the first and second controllable bidirectional switches and the second DC terminal, wherein in a positive half cycle of an AC voltage between the first and second AC terminals, the first controllable bidirectional switch is closed and the second controllable bidirectional switch is opened, and wherein in a negative half cycle of the AC voltage, the first controllable bidirectional switch is opened and the second controllable bidirectional switch is closed.

In some embodiments, each of the first and second coupling inductors comprises first and second windings, and the second end of the first winding and the first end of the second winding are namesake ends; and wherein the plurality of branches comprise a first branch connected to the first winding of the first coupling inductor, a second branch connected to the second winding of the first coupling inductor, a third branch connected to the first winding of the second coupling inductor, and a fourth branch connected to the second winding of the second coupling inductor.

In some embodiments, in a positive half cycle of an AC voltage between the first and second AC terminals, the low-side controllable semiconductor devices of the third and fourth branches are switched on and the high-side controllable semiconductor devices of the third and fourth branches are switched off, the high-side and low-side controllable semiconductor devices of the first branch are switched on and off alternatively, the high-side and low-side controllable semiconductor devices of the second branch are switched on and off alternatively, and control signals for switching the first and second branches are phase-shifted by 180 degree; and in a negative half cycle of the AC voltage, the high-side controllable semiconductor devices of the first and second branches are switched on and the low-side controllable semiconductor devices of the first and second branches are switched off, the high-side and low-side controllable semiconductor devices of the third branch are switched on and off alternatively, the high-side and low-side controllable semiconductor devices of the fourth branch are switched on and off alternatively, and control signals for switching the third and fourth branches are phase-shifted by 180 degree.

In some embodiments, the switching circuit comprises: a first controllable bidirectional switch and a first capacitor connected in series between the first AC terminal and the second DC terminal; and a second controllable bidirectional switch and a second capacitor connected in series between the second AC terminal and the second DC terminal, wherein in a positive half cycle of an AC voltage between the first and second AC terminals, the first controllable bidirectional switch is closed and the second controllable bidirectional switch is opened, and wherein in a negative half cycle of the AC voltage, the first controllable bidirectional switch is opened and the second controllable bidirectional switch is closed.

In some embodiments, each of the first and second coupling inductors comprises first, second and third windings, and the first ends of the first, second and third windings are namesake ends; and the plurality of branches comprise a first branch connected to the first winding of the first coupling inductor, a second branch connected to the second winding of the first coupling inductor, a third branch connected to the first winding of the second coupling inductor, a fourth branch connected to the second winding of the second coupling inductor, a fifth branch connected to the third winding of the first coupling inductor, and a sixth branch connected to the third winding of the second coupling inductor.

In some embodiments, in a positive half cycle of an AC voltage between the first and second AC terminals, the low-side controllable semiconductor devices of the third, fourth and sixth branches are switched on and the high-side controllable semiconductor devices of the third, fourth and sixth branches are switched off, the high-side and low-side controllable semiconductor devices of the first branch are switched on and off alternatively, the high-side and low-side controllable semiconductor devices of the second branch are switched on and off alternatively, the high-side and low-side controllable semiconductor devices of the fifth branch are switched on and off alternatively, and control signals for switching the first, second and fifth branches are phase-shifted by 120 degree; and in a negative half cycle of the AC voltage, the high-side controllable semiconductor devices of the first, second and fifth branches are switched on and the low-side controllable semiconductor devices of the first, second and fifth branches are switched off, the high-side and low-side controllable semiconductor devices of the third branch are switched on and off alternatively, the high-side and low-side controllable semiconductor devices of the fourth branch are switched on and off alternatively, the high-side and low-side controllable semiconductor devices of the sixth branch are switched on and off alternatively, and control signals for switching the third, fourth and sixth branches are phase-shifted by 120 degree.

In a second aspect of the present disclosure, example embodiments of the present disclosure provide an industrial robot comprising the power factor correction circuit according to the first aspect of the present disclosure.

According to various embodiments of the present disclosure, due to the use of the controllable semiconductor devices in the power converting unit, the PFC circuit may achieve bidirectional power flow capability so as to feed the regenerative power generated during the brakes of the motors in the robot back to the power grid.

In addition, due to the use of the coupling inductors, the size of the filter in the PFC circuit and thus the size of the whole controller of the robot can be reduced. Also, due to the use of the coupling inductors, it is ensured that the current through power converting channels in the power converting unit are balanced.

Further, the switching circuit may transform a conventional L filter in the PFC circuit into a LCL filter, further reducing the size of the PFC circuit. In addition, the leakage current may be suppressed by the switching circuit.

In view of the above, the proposed PFC circuit is a competitive option for small and middle size robots.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 illustrates a schematic circuit diagram of a PFC circuit in accordance with an embodiment of the present disclosure;

FIG. 2 illustrates operation waveforms of voltages at various points in the PFC circuit in the positive half cycle of the AC voltage;

FIG. 3 illustrates an equivalent circuit diagram of a filter in the PFC circuit as shown in FIG. 1 in a positive half cycle of an AC voltage;

FIG. 4 illustrates an equivalent circuit diagram of the filter in the PFC circuit as shown in FIG. 1 in the positive half cycle of an AC voltage in consideration of the leakage capacitance;

FIG. 5 illustrates a schematic circuit diagram of a PFC circuit in accordance with another embodiment of the present disclosure; and

FIG. 6 illustrates a schematic circuit diagram of a PFC circuit in accordance with yet another embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the figures. Other definitions, explicit and implicit, may be included below.

As discussed above, the PFC circuit for the industrial robot is required to have the bidirectional power conversion capability, the leakage current suppression capability and small size. According to embodiments of the present disclosure, to minimize the size of the PFC circuit and suppress the leakage current, the two coupling inductors and the switching circuit are introduced into the PFC circuit. The above idea may be implemented in various manners, as will be described in detail in the following paragraphs.

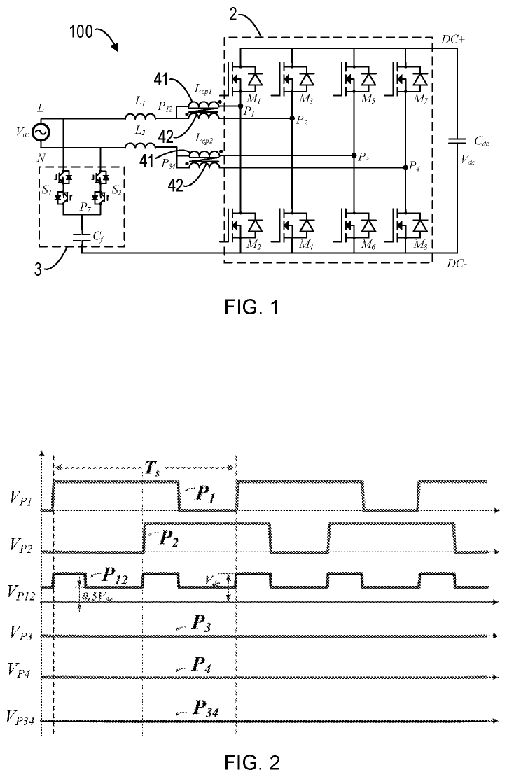

Hereinafter, the principles of the present disclosure will be described in detail with reference to FIGS. 1-6. Referring to FIG. 1 first, FIG. 1 illustrates a schematic circuit diagram of a PFC circuit 100 in accordance with an embodiment of the present disclosure. As shown in FIG. 1, the PFC circuit 100 generally includes first and second AC terminals L, N, first and second DC terminals DC+, DC−, first and second input inductors L1, L2, first and second coupling inductors Lcp1, Lcp2, a power converting unit 2, and a switching circuit 3.

The PFC circuit 100 may operate bi-directionally. When the PFC circuit 100 operates as a rectifier, the PFC circuit 100 receives an AC voltage Vac from the power grid at the first and second AC terminals L, N and outputs a DC voltage Vdc at the first and second DC terminals DC+, DC−. When the PFC circuit 100 operates as an inverter, the PFC circuit 100 receives a DC voltage Vdc at the first and second DC terminals DC+, DC− and outputs an AC voltage Vac to the power grid at the first and second AC terminals L, N.

The first input inductor L1 is connected to the first AC terminal L at an end and to the first coupling inductor Lcp1 at the other end. The second input inductor L2 is connected to the second AC terminal N at an end and to the second coupling inductor Lcp2 at the other end.

Each of the first and second coupling inductors Lcp1, Lcp2 includes first and second windings 41, 42. Each of the first and second windings 41, 42 includes first and second ends. The first ends of the first and second windings 41, 42 of the first coupling inductor Lcp1 are connected to the first input inductor L1 at a point P12. The first ends of the first and second windings 41, 42 of the second coupling inductor Lcp2 are connected to the second input inductor L2 at a point P34. In each of the first and second coupling inductors Lcp1, Lcp2, the second end of the first winding 41 and the first end of the second winding 42 are namesake ends.

The power converting unit 2 includes four branches connected in parallel between the first and second DC terminals DC+, DC−, i.e., a first branch including high-side and low-side controllable semiconductor devices M1, M2 having a middle point P1, a second branch including high-side and low-side controllable semiconductor devices M3, M4 having a middle point P2, a third branch including high-side and low-side controllable semiconductor devices M5, M6 having a middle point P3, and a fourth branch including high-side and low-side controllable semiconductor devices M7, M8 having a middle point P4. The middle point P1 is connected to the second end of the first winding 41 of the first coupling inductor Lcp1. The middle point P2 is connected to the second end of the second winding 42 of the first coupling inductor Lcp1. The middle point P3 is connected to the second end of the first winding 41 of the second coupling inductor Lcp2. The middle point P4 is connected to the second end of the second winding 42 of the second coupling inductor Lcp2. The first and third branches may form a power converting channel and the second and fourth branches may form another power converting channel.

In embodiments of the present disclosure, the controllable semiconductor devices M1-M8 in the power converting unit 2 may be of various types, for example MOSFET, and the like. The scope of the present disclosure is not intended to be limited in this respect. Due to the use of the controllable semiconductor devices in the power converting unit 2, the PFC circuit 100 may achieve bidirectional power flow capability so as to feed the regenerative power generated during the brakes of the motors in the robot back to the power grid.

In a positive half cycle of the AC voltage Vac between the first and second AC terminals L, N, the low-side controllable semiconductor devices M6, M8 of the third and fourth branches are switched on and the high-side controllable semiconductor devices M5, M7 of the third and fourth branches are switched off. The high-side and low-side controllable semiconductor devices M1, M2 of the first branch are switched on and off alternatively. The high-side and low-side controllable semiconductor devices M3, M4 of the second branch are switched on and off alternatively. Control signals for switching the first and second branches are phase-shifted by 180 degree.

FIG. 2 illustrates operation waveforms of voltages at various points in the PFC circuit 100 in the positive half cycle of the AC voltage. As shown in FIG. 2, the voltage Vp2 at the point P2 lags the voltage Vp1 at the point P1 by a half of the switching cycle Ts of the high-side and low-side controllable semiconductor devices M1, M2, M3, M4, because the control signals for switching the first and second branches are phase-shifted by 180 degree. The frequency of the voltage Vp12 at the point P12 is twice of the switching frequency of the high-side and low-side controllable semiconductor devices M1, M2, M3, M4. The fluctuation magnitude of the voltage Vp12 at the point P12 is a half of the voltage Vdc at the first and second DC terminals DC+, DC−. Further, the voltages Vp3, Vp4 and Vp34 at the points P3, P4 and P34 are at low level. The size of the first and second coupling inductors Lcp1, Lcp2 can be small due to the double frequency effect. In addition, the size of the filter in the PFC circuit 100 and thus the size of the whole controller of the robot can be reduced.

In the negative half cycle of the AC voltage Vac, the high-side controllable semiconductor devices M1, M3 of the first and second branches are switched on and the low-side controllable semiconductor devices M2, M4 of the first and second branches are switched off. The high-side and low-side controllable semiconductor devices M5, M6 of the third branch are switched on and off alternatively. The high-side and low-side controllable semiconductor devices M7, M8 of the fourth branch are switched on and off alternatively. Control signals for switching the third and fourth branches are phase-shifted by 180 degree. The operation process of the power converting unit 2 in the negative half cycle of the AC voltage Vac is similar to that in the positive half cycle of the AC voltage, and would not be described in detail herein.

In addition, due to the use of the coupling inductors Lcp1 and Lcp2, the currents through the two power converting channels in the power converting unit 2 are almost the same, which ensures power and thermal balance of the two channels.

As shown in FIG. 1, the switching circuit 3 is arranged between the first and second AC terminals L, N and the second DC terminal DC− so as to suppress a leakage current of the power factor correction circuit 100. In an embodiment, as shown in FIG. 1, the switching circuit 3 includes first and second controllable bidirectional switches S1, S2 and a capacitor Cf. The first and second controllable bidirectional switches S1, S2 are connected in series between the first and second AC terminals L, N. The capacitor Cf is connected between a connection point P7 between the first and second controllable bidirectional switches S1, S2 and the second DC terminal DC−.

In the positive half cycle of the AC voltage Vac, the first controllable bidirectional switch S1 is closed and the second controllable bidirectional switch S2 is opened. The first and second input inductors L1, L2 and the capacitor Cf form an LCL filter between the power grid and the first and second coupling inductors Lcp1, Lcp2. In such a case, the second input inductor L2 takes the role of a grid inductor, and thereby a low grid deferential current ripple is achieved. Further, the capacitor Cf is coupled between the first AC terminal L and the second DC terminal DC−, and thereby the potential difference between them is clamped, and thus a low leakage current is achieved.

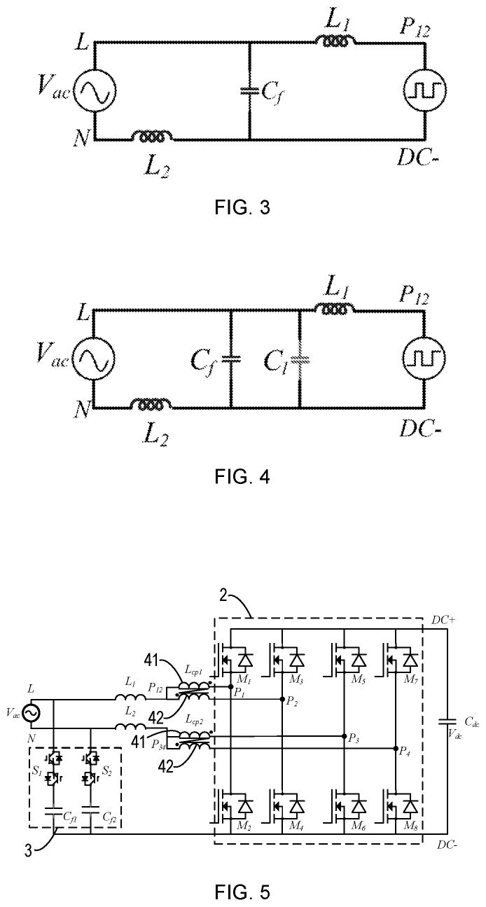

In the positive half cycle of the AC voltage Vac, the points P3 and P4 are connected to the second DC terminal DC−, since the low-side controllable semiconductor devices M6, M8 of the third and fourth branches are switched on. Thus, the equivalent circuit of the filter in the PFC circuit 100 is as shown in FIG. 3. Since the first controllable bidirectional switch S1 is closed and the second controllable bidirectional switch S2 is opened in the positive half cycle, the capacitor Cf is connected between the first AC terminal L and the second DC terminal DC−. Thus, the first and second input inductors L1, L2 and the capacitor Cf form the LCL filter, which reduces the size of the filter in the PFC circuit 100.

In case of considering a leakage capacitance C1, the equivalent circuit of the filter in the PFC circuit 100 is as shown in FIG. 4. The leakage capacitance C1 is typically much lower than the capacitor Cf Since the capacitor Cf is connected in parallel with the leakage capacitance C1, the leakage current through the leakage capacitance C1 becomes much lower.

In the negative half cycle of the AC voltage Vac, the first controllable bidirectional switch S1 is opened and the second controllable bidirectional switch S2 is closed. The first and second input inductors L1, L2 and the capacitor Cf form an LCL filter between the power grid and the first and second coupling inductors Lcp1, Lcp2. In such a case, the first input inductor L1 takes the role of a grid inductor, and a low grid deferential current ripple is achieved. Further, the capacitor Cf is coupled between the second AC terminal N and the second DC terminal DC- and the potential difference between them is clamped; therefore, a low leakage current is achieved.

FIG. 5 illustrates a schematic circuit diagram of a PFC circuit 100 in accordance with another embodiment of the present disclosure. The construction of the PFC circuit 100 as shown in FIG. 5 is similar to that of the PFC circuit 100 as shown in FIG. 1. The difference between the PFC circuits 100 as shown in FIGS. 5 and 1 line in the construction of the switching circuit 3. As shown in FIG. 5, the switching circuit 3 includes first and second controllable bidirectional switches S1, S2 and first and second capacitors Cf1, Cf2. The first controllable bidirectional switch S1 and the first capacitor Cf1 are connected in series between the first AC terminal L and the second DC terminal DC−. The second controllable bidirectional switch S2 and the second capacitor Cf2 are connected in series between the second AC terminal N and the second DC terminal DC−.

In the positive half cycle of the AC voltage Vac, the first controllable bidirectional switch S1 is closed and the second controllable bidirectional switch S2 is opened. The first and second input inductors L1, L2 and the first capacitor Cf1 form an LCL filter between the power grid and the first and second coupling inductors Lcp1, Lcp2. In such a case, the second input inductor L2 takes the role of a grid inductor, and thereby a low grid deferential current ripple is achieved. Further, the first capacitor Cf1 is coupled between the first AC terminal L and the second DC terminal DC−, and thereby the potential difference between them is clamped, and thus a low leakage current is achieved.

In the negative half cycle of the AC voltage Vac, the first controllable bidirectional switch S1 is opened and the second controllable bidirectional switch S2 is closed. The first and second input inductors L1, L2 and the second capacitor Cf2 form an LCL filter between the power grid and the first and second coupling inductors Lcp1, Lcp2. In such a case, the first input inductor L1 takes the role of a grid inductor, and a low grid deferential current ripple is achieved. Further, the second capacitor Cf2 is coupled between the second AC terminal N and the second DC terminal DC− and the potential difference between them is clamped; therefore, a low leakage current is achieved.

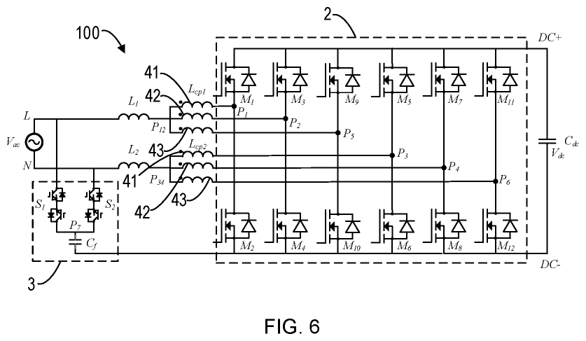

FIG. 6 illustrates a schematic circuit diagram of a PFC circuit 100 in accordance with yet another embodiment of the present disclosure. The construction of the PFC circuit 100 as shown in FIG. 6 is similar to that of the PFC circuit 100 as shown in FIG. 1. The difference between the PFC circuits 100 as shown in FIGS. 6 and 1 line in the construction of the first and second coupling inductors Lcp1, Lcp2 and the power converting unit 2.

As shown in FIG. 6, each of the first and second coupling inductors Lcp1, Lcp2 includes first, second and third windings 41, 42, 43. Each of the first, second and third windings 41, 42, 43 includes first and second ends. The first ends of the first, second and third windings 41, 42, 43 of the first coupling inductor Lcp1 are connected to the first input inductor L1. The first ends of the first, second and third windings 41, 42, 43 of the second coupling inductor Lcp2 are connected to the second input inductor L2. In each of the first and second coupling inductors Lcp1, Lcp2, the first ends of the first, second and third windings 41, 42, 43 are namesake ends.

The power converting unit 2 includes six branches connected in parallel between the first and second DC terminals DC+, DC−, i.e., a first branch including high-side and low-side controllable semiconductor devices M1, M2 having a middle point P1, a second branch including high-side and low-side controllable semiconductor devices M3, M4 having a middle point P2, a third branch including high-side and low-side controllable semiconductor devices M5, M6 having a middle point P3, a fourth branch including high-side and low-side controllable semiconductor devices M7, M8 having a middle point P4, a fifth branch including high-side and low-side controllable semiconductor devices M9, M10 having a middle point P5, and a sixth branch including high-side and low-side controllable semiconductor devices M11, M12 having a middle point P6. The middle point P1 is connected to the second end of the first winding 41 of the first coupling inductor Lcp1. The middle point P2 is connected to the second end of the second winding 42 of the first coupling inductor Lcp1. The middle point P3 is connected to the second end of the first winding 41 of the second coupling inductor Lcp2. The middle point P4 is connected to the second end of the second winding 42 of the second coupling inductor Lcp2. The middle point P5 is connected to the second end of the third winding 43 of the first coupling inductor Lcp1. The middle point P6 is connected to the second end of the third winding 43 of the second coupling inductor Lcp2.

In embodiments of the present disclosure, the controllable semiconductor devices M1-M12 in the power converting unit 2 may be of various types, for example MOSFET, and the like. The scope of the present disclosure is not intended to be limited in this respect.

In the positive half cycle of the AC voltage Vac, the low-side controllable semiconductor devices M6, M8, M12 of the third, fourth and sixth branches are switched on and the high-side controllable semiconductor devices M5, M7, M11 of the third, fourth and sixth branches are switched off. The high-side and low-side controllable semiconductor devices M1, M2 of the first branch are switched on and off alternatively. The high-side and low-side controllable semiconductor devices M3, M4 of the second branch are switched on and off alternatively. The high-side and low-side controllable semiconductor devices M9, M10 of the fifth branch are switched on and off alternatively. Control signals for switching the first, second and fifth branches are phase-shifted by 120 degree.

In the negative half cycle of the AC voltage Vac, the high-side controllable semiconductor devices M1, M3, M9 of the first, second and fifth branches are switched on and the low-side controllable semiconductor devices M2, M4, M10 of the first, second and fifth branches are switched off. The high-side and low-side controllable semiconductor devices M5, M6 of the third branch are switched on and off alternatively. The high-side and low-side controllable semiconductor devices M7, M8 of the fourth branch are switched on and off alternatively. The high-side and low-side controllable semiconductor devices M11, M12 of the sixth branch are switched on and off alternatively. Control signals for switching the third, fourth and sixth branches are phase-shifted by 120 degree.

Although the principles of the present disclosure have been described as above by taking the robot including the PFC circuit 100 as an example, it is to be understood that the PFC circuit 100 as described above with reference to FIGS. 1-6 may be implemented in various electrical devices.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A power factor correction circuit comprising:
first and second AC terminals;
first and second DC terminals;
a first input inductor connected to the first AC terminal;
a second input inductor connected to the second AC terminal;
a first coupling inductor comprising a first plurality of windings, each of the first plurality of windings comprising a first end connected to the first input inductor and a second end;
a second coupling inductor comprising a second plurality of windings of the same number as the first plurality of windings, each of the second plurality of windings comprising a first end connected to the second input inductor and a second end;
a power converting unit comprising a plurality of branches connected in parallel between the first and second DC terminals, each of the branches comprising high-side and low-side controllable semiconductor devices, wherein the second end of each of the first and second plurality of windings is connected to a middle point between the respective high-side and low-side controllable semiconductor devices; and
a switching circuit arranged between the first and second AC terminals and the second DC terminal and configured to suppress a leakage current of the power factor correction circuit.

2. The power factor correction circuit according to claim 1, wherein each of the high-side and low-side controllable semiconductor devices comprises MOSFET.

3. The power factor correction circuit according to claim 1, wherein the switching circuit comprises:
first and second controllable bidirectional switches connected in series between the first and second AC terminals; and
a capacitor connected between a connection point between the first and second controllable bidirectional switches and the second DC terminal,
wherein in a positive half cycle of an AC voltage between the first and second AC terminals, the first controllable bidirectional switch is closed and the second controllable bidirectional switch is opened, and
wherein in a negative half cycle of the AC voltage, the first controllable bidirectional switch is opened and the second controllable bidirectional switch is closed.

4. The power factor correction circuit according to claim 1, wherein each of the first and second coupling inductors comprises first and second windings, and the second end of the first winding and the first end of the second winding are namesake ends; and
wherein the plurality of branches comprise a first branch connected to the first winding of the first coupling inductor, a second branch connected to the second winding of the first coupling inductor, a third branch connected to the first winding of the second coupling inductor, and a fourth branch connected to the second winding of the second coupling inductor.

5. The power factor correction circuit according to claim 4, wherein in a positive half cycle of an AC voltage between the first and second AC terminals, the low-side controllable semiconductor devices of the third and fourth branches are switched on and the high-side controllable semiconductor devices of the third and fourth branches are switched off, the high-side and low-side controllable semiconductor devices of the first branch are switched on and off alternatively, the high-side and low-side controllable semiconductor devices of the second branch are switched on and off alternatively, and control signals for switching the first and second branches are phase-shifted by 180 degree; and
wherein in a negative half cycle of the AC voltage, the high-side controllable semiconductor devices of the first and second branches are switched on and the low-side controllable semiconductor devices of the first and second branches are switched off, the high-side and low-side controllable semiconductor devices of the third branch are switched on and off alternatively, the high-side and low-side controllable semiconductor devices of the fourth branch are switched on and off alternatively, and control signals for switching the third and fourth branches are phase-shifted by 180 degree.

6. The power factor correction circuit according to claim 1, wherein the switching circuit comprises:
a first controllable bidirectional switch and a first capacitor connected in series between the first AC terminal and the second DC terminal; and
a second controllable bidirectional switch and a second capacitor connected in series between the second AC terminal and the second DC terminal,
wherein in a positive half cycle of an AC voltage between the first and second AC terminals, the first controllable bidirectional switch is closed and the second controllable bidirectional switch is opened, and
wherein in a negative half cycle of the AC voltage, the first controllable bidirectional switch is opened and the second controllable bidirectional switch is closed.

7. The power factor correction circuit according to claim 1, wherein each of the first and second coupling inductors comprises first, second and third windings, and the first ends of the first, second and third windings are namesake ends; and
wherein the plurality of branches comprise a first branch connected to the first winding of the first coupling inductor, a second branch connected to the second winding of the first coupling inductor, a third branch connected to the first winding of the second coupling inductor, a fourth branch connected to the second winding of the second coupling inductor, a fifth branch connected to the third winding of the first coupling inductor, and a sixth branch connected to the third winding of the second coupling inductor.

8. The power factor correction circuit according to claim 7, wherein in a positive half cycle of an AC voltage between the first and second AC terminals, the low-side controllable semiconductor devices of the third, fourth and sixth branches are switched on and the high-side controllable semiconductor devices of the third, fourth and sixth branches are switched off, the high-side and low-side controllable semiconductor devices of the first branch are switched on and off alternatively, the high-side and low-side controllable semiconductor devices of the second branch are switched on and off alternatively, the high-side and low-side controllable semiconductor devices of the fifth branch are switched on and off alternatively, and control signals for switching the first, second and fifth branches are phase-shifted by 120 degree; and
wherein in a negative half cycle of the AC voltage, the high-side controllable semiconductor devices of the first, second and fifth branches are switched on and the low-side controllable semiconductor devices of the first, second and fifth branches are switched off, the high-side and low-side controllable semiconductor devices of the third branch are switched on and off alternatively, the high-side and low-side controllable semiconductor devices of the fourth branch are switched on and off alternatively, the high-side and low-side controllable semiconductor devices of the sixth branch are switched on and off alternatively, and control signals for switching the third, fourth and sixth branches are phase-shifted by 120 degree.

9. An industrial robot comprising the power factor correction circuit according to claim 1.

10. An industrial robot comprising the power factor correction circuit according to claim 2.

11. An industrial robot comprising the power factor correction circuit according to claim 3.

12. An industrial robot comprising the power factor correction circuit according to claim 4.

13. An industrial robot comprising the power factor correction circuit according to claim 5.

14. An industrial robot comprising the power factor correction circuit according to claim 6.

15. An industrial robot comprising the power factor correction circuit according to claim 7.

16. An industrial robot comprising the power factor correction circuit according to claim 8.
